(19) United States
(12) Patent Application Publication
(10) Pub. No.: US 2017/0004440 A1
(43) Pub. Date: Jan. 5, 2017

(54) Systems and Methods for Managing Article Supply, Allocation, and Distribution

(71) Applicant: Innova Zones, LLC, Fort Worth, TX (US)

(72) Inventors: Travis Brandon Barker, Fort Worth, TX (US); Travis Brian Barker, Amarillo, TX (US)

(21) Appl. No.: 14/755,247

(22) Filed: Jun. 30, 2015

(51) Int. Cl. G06Q 10/08; G06Q 10/06

(52) U.S. Cl. CPC G06Q 10/087; G06Q 10/0631

(57) ABSTRACT

Described herein are systems and methods for managing article allocation and distribution. A facility may be divided into a plurality of job zones and personnel members may be associated with one or more of the job zones. Each job zone may be associated with a predetermined list of articles or equipment suitable for use by personnel in the zone's environment. Personnel may order or request articles for use by selecting a body portion of a humanoid avatar. Available articles corresponding to the selected body portion and suitable for use in the job zone associated with the personnel member may then be displayed for further selection. The described systems and methods may also be used to, among other things, check articles in and out of inventory, track the location of articles, monitor who is in possession of articles, track the effectiveness of distributed articles, and record personnel's use of articles.

### BACKGROUND

Managing article and resource allocation and distribution in today's workplace is of paramount concern. Personnel across a number of fields rely on their workplace equipment and attire to ensure their own safety and the safety of others. It is also incumbent on employers and facility managers to ensure that their workforce is utilizing suitable equipment and wearing approved articles while on the jobsite.

Given the language barriers often encountered in today's workplace, it is also important to provide personnel with processes and systems for securing proper articles and equipment in an intuitive fashion that avoids misinterpretations or miscommunications. Article and equipment management systems available today are typically language-based, relying on either oral or written communications. Despite efforts to communicate with personnel in a number of languages, such systems have inherent risks and limitations associated with translation issues. Moreover, written communications, regardless of language, pose problems to illiterate personnel.

Employers and equipment managers must also carefully budget for article and equipment expenditures. A balance must be achieved between, on the one hand, ensuring sufficient and suitable equipment is always available to personnel, and on the other hand, limiting or eliminating waste, i.e., over-ordering of equipment or careless use of articles by employees.

In conjunction with supplying equipment to personnel, many employers and managers provide their workforce with vouchers or financial aid to offset the cost of purchasing or renting needed equipment. While these voucher programs are valued benefits from a personnel perspective, they can be difficult to administer and track. For example, under a typical voucher program, an employee may find an article or equipment piece he or she desires to purchase for use at the workplace. The employee must then submit a request to a supervisor or manager to approve the article for use and issue a voucher for its purchase. Only after receiving such approval and the voucher can the employee order the article. This process is not only frustrating and time-consuming for the employee, but the employer or manager may have a difficult time determining whether the employee-selected article is suitable for use in the employee's particular work environment, how the requested voucher fits in with a larger budget for corresponding articles, whether the issued voucher was actually used for the approved article, or whether the employee has already received a voucher (or otherwise possesses) a substantially similar article. The process becomes even more cumbersome when a workplace comprises a plurality of work environments, each with its own unique characteristics, and an employer or manager must determine in what environment a requested article will be used or whether the requesting employee has a need for a particular item given the environment in which that employee typically works.

Many of the same concerns are present where employees check equipment in and out of inventory. For example, present systems and methods do not provide employers or managers efficient techniques for determining how much equipment they need on-hand, how frequently particular items are checked in and out, wear and tear on items, or individual employee's history with company resources.

Thus, a need exists for improved systems and techniques for ordering, managing, distributing, and tracking workplace articles and equipment. Moreover, improved systems and techniques are needed to ensure personnel safety, overcome language barriers, and safeguard company resources.

### SUMMARY OF THE DISCLOSURE

In accordance with certain embodiments of the present disclosure, systems and methods for efficient management of workplace articles and equipment are disclosed. As used herein, “personnel” may be used to describe a group of individuals or a single individual, and may be used to describe employees (whether salaried or paid hourly), contractors, administrators, executives, officers, vendors, third party service providers, or any other person or persons performing work or tasks at the request or direction of another individual or entity. The term “article,” “item,” or “equipment” may also be used interchangeably and are intended to describe any clothing item, safety gear, equipment piece, tool, or other resource that personnel may use within a work environment.

In one aspect, methods described herein can comprise receiving information associated with a personnel member, associating that personnel member with at least one of a plurality of job zones present in a facility or workplace, displaying a humanoid avatar comprising a plurality of body zones, and upon receiving a selection of a body zone, displaying one or more items corresponding to the selected body zone that are associated with the personnel member and suitable for use within the member's job zone.

In another aspect, the methods personnel members may be associated with personnel-specific information. Personnel-specific information may include age, weight, sex, and clothing sizes. Personnel-specific information may further comprise voucher information and which items are displayed to the personnel member may be based, at least in part, on the voucher information. For example, in some embodiments, only items associated with an amount equal to or less than the personnel member's voucher may be displayed. Alternatively, items may be displayed in conjunction with a visual indicator communicating whether each item's associated value is less than or exceeds a value associated with the personnel member's voucher.

In a further aspect, the items may be displayed in conjunction with an image of the item. The methods described herein may further comprise receiving a selection of one or more of the items from the personnel member and then transmitting a request for the selected items.

In another aspect, a device comprising a display, a processor, and a computer-readable memory is described. In one embodiment, the device is configured to identify an individual, determine a job zone associated with the individual, and display an icon comprising a plurality of body regions, each body region associated with corresponding articles or equipment suitable for use at that region of the body and within the associated job zone. In some embodiments, plurality of body regions of the icon may be differentiated based on visual indicators, such as boundary lines or color-coded areas. The device may be further configured to receive a selection of a body region and display the corresponding articles or equipment pieces.

A user may then select one or more of the displayed articles or equipment pieces and the device may transmit an order request or a check-out request based on the user's selection.

In some embodiments, the job zone associated with the individual may be one or a plurality of job zones within a facility. Job zones may be differentiated from one another based on respective environmental considerations, activities taking place in each zone, and/or safety considerations unique to each zone (collectively or individually, an “environmental analysis”). The articles or equipment displayed to the user and/or associated with the individual can be pre-approved or otherwise uniquely suited for use in the associated job zone.

In further embodiments, the device may comprise a camera for capturing an image of the user executing a transaction (i.e., ordering or check-out an article). The image may be stored for later use in validating the transaction or otherwise serving as proof that the transaction occurred or that the individual executing the transaction had authority to do so. Alternatively or additionally, the camera may capture an image of the article being ordered or checked-out. Such an image may be stored for later use to serve as proof that the transaction occurred or to demonstrate the condition of the article at the time it was placed in the user's possession.

A system comprising a personnel device and an administrative device is also described herein. In one aspect, the personnel device may be configured to receive information identifying a personnel member and display an icon representative of the human body, the icon comprising a plurality of discrete body zones. A selection of a body zone may be received at the personnel device and, in response, the personnel device may display a list of articles corresponding to the selected body zone and suitable for use in the personnel member's role at a facility or within a particular job zone.

In another aspect, the personnel device can receive a selection of one or more displayed articles and transmit a check-out request to the administrative device comprising the selected articles.

The administrative device may be configured to receive the check-out request and display the one or more selected articles. The administrative device may be further configured to display information identifying the personnel member associated with the check-out request.

After checking out or dispensing the selected articles to the personnel member, the administrative device may be further configured to accept input and transmit a message indicating that the personnel member has received the selected articles.

Transactional data can be recorded and stored to provide reports based on article/equipment use, individual item history, personnel history, and/or job zone analysis.

Additional objects and advantages of the present disclosure will be set forth in part in the description which follows, and in part will be obvious from the description, or may be learned by practice of the disclosure. One or more of the objects and advantages of the disclosure can be realized and attained by the embodiments and combinations particularly pointed out in the appended claims.

It is to be understood that both the foregoing general description and the following detailed description are illustrative and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an illustrative embodiment of a system as described herein.

FIG. 2 depicts some aspects of an illustrative embodiment of system as described herein.

FIG. 3 depicts an illustrative embodiment of a computing system as described herein.

FIG. 4 depicts some aspects of an illustrative embodiment of a method as described herein.

FIG. 5 depicts some aspects of an illustrative embodiment of a method as described herein.

FIG. 6 depicts some aspects of an illustrative embodiment of a system as described herein.

FIG. 7 depicts some aspects of an illustrative embodiment of a method as described herein.

FIG. 8 depicts some aspects of an illustrative embodiment of a system as described herein.

FIG. 9 depicts some aspects of an illustrative embodiment of a system as described herein.

### DESCRIPTION OF THE EMBODIMENTS

Disclosed herein are embodiments of systems, devices, and methods for managing article allocation and distribution. In one aspect, a workplace or facility may be divided into one or more job zones based, at least in part, on environmental considerations, activities occurring within each job zone, and safety considerations unique to each job zone. Personnel within the workplace or facility may be associated with one or more job zones in which they participate or have a role.

An analysis of each job zone may be conducted to identify one or more articles or equipment pieces suitable, desirable, or necessary for work within each job zone. Such analysis may be conducted in conjunction with a review of applicable safety regulations, budget allocations or constraints, and/or feedback or input from a supervisor, manager, or facility.

In another aspect, ordering or checking out articles to a personnel member may be accomplished by receiving information identifying the personnel member, determining the one or more job zones associated with the personnel member, and receiving a selection of one of a plurality of body zones displayed in conjunction with an avatar or humanoid icon. Upon receiving the body zone selection, articles corresponding to that body zone may be displayed. The displayed items may be based, at least in part, on the job zone(s) associated with the personnel member and, in some embodiments, may be pre-approved, or otherwise confirmed to be suitable, for use within the respective job zone(s).

In a further aspect, the systems, devices, and methods described herein can be used in the context of ordering articles and take into account voucher or budget information associated with individual personnel members, personnel groups, or job zones. Voucher or budget information can, for example, be used to limit distribution of one or more items, limit distribution of items with respect to individual personnel members, guarantee that the articles or equipment distributed to a personnel member are suitable for that individual within the individual's job zone, and ensure adherence to a facility's or department's budget. The systems, devices, and methods may also be used in the context of onsite checking out and checking in of facility resources. Such systems, devices, and methods may also comprise features to authenticate transactions, store historical information, and monitor the use and availability of resources.

Reference will now be made in detail to certain illustrative embodiments, examples of which are illustrated in the accompanying drawings. Wherever possible, the same reference numbers will be used throughout the drawings to refer to the same or like items.

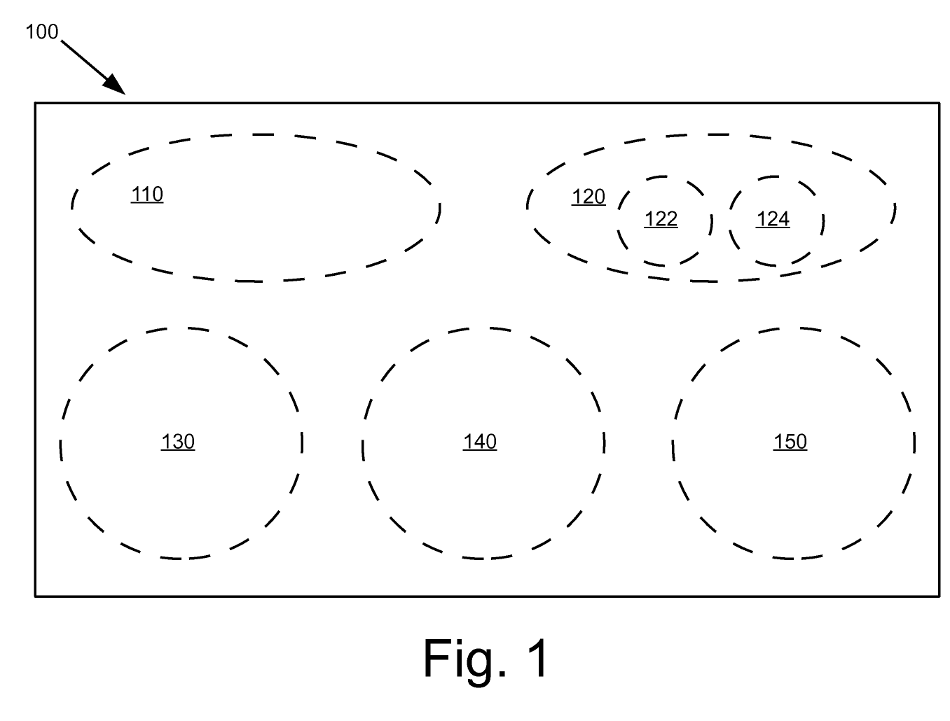

FIG. 1 depicts an illustrative embodiment of a facility 100. In one embodiment, facility 100 can comprise a physical facility (e.g., brick-and-mortar facility). In another embodiment, facility 100 may be “virtual,” i.e., comprise a virtual representation of an entity's resources, a virtual representation of multiple physically- or geographically-distinct facilities, and/or some combination thereof. For example, facility 100 may comprise an agricultural facility operated by Company A. Alternatively, facility 100 may comprise all agricultural facilities, regardless of physical location, operated by Company A. In still further embodiments, facility 100 may comprise one or more agricultural, storage, and distribution facilities, regardless of physical location.

In one aspect, facility 100 may comprise one or more job zones 110, 120, 130, 140, 150. In one embodiment, the job zones may represent physically-distinct areas within facility 100 or roles of varying personnel within facility 100. For example, job zone 110 may be an outdoor area of facility 100, job zone 120 may be a sanitized, interior processing area of facility 100, and job zone 130 may be a distribution or shipping area of facility 100. Or, in an embodiment in which facility 100 is a virtual facility, job zones 110, 120, and 130 may represent a collection of multiple outdoor, processing, and distribution/shipping areas, respectively, located across a number of physically-distinct locations that may be managed by a common entity. In another embodiment, job zone 110 may comprise administrative personnel, job zone 120 may comprise labor personnel, and job zone 130 may comprise transportation personnel. Of course, all of the aforementioned examples or only illustrative of the possibilities and facility 100, whether a physical or virtual facility, may be subdivided into a number of suitable job zones.

In another aspect, each job zone may be associated with one or more articles or pieces of equipment utilized by personnel within that job zone. In one embodiment, the personnel of job zone 110 may require or utilize articles and equipment different from those used by personnel in job zone 120. In another embodiment, the articles or equipment used in works zones 110 and 120 may partially or completely overlap. In a further embodiment, a job zone 120 may comprise further job zones 122 and 124. For example, job zone 120 may be a processing zone of facility 100. Job zone 122, within processing zone 120, may be a sorting zone and job zone 124 may be a chemical treatment zone. Personnel within job zone 120 may utilize common articles or equipment, but personnel in zone 122 may require further articles/equipment unnecessary in the remainder of job zone 120. Similarly, personnel of zone 124 may require further articles/equipment unnecessary in the remainder of job zone 120 and mutually exclusive with respect to articles/equipment used in job zone 122.

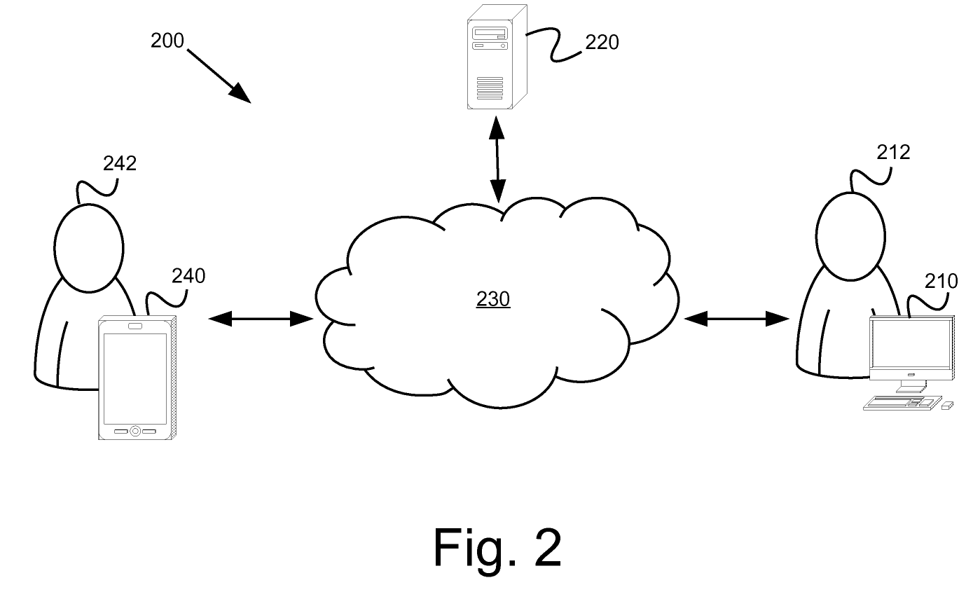

FIG. 2 depicts an illustrative embodiment of a system 200 for the management, allocation, and/or distribution of articles or equipment across facility 100. In one embodiment, system 200 can comprise an administrative client device 210, a management server 220, a communication network 230, and one or more personnel devices 240. In the depicted embodiment, administrative client device 210, which may be associated with one or more administrators 212, can comprise a desktop computer. In alternative embodiments, device 210 may comprise a cellphone, smartphone, laptop, tablet, terminal, kiosk, or any other controller- or processor-based, mobile or non-mobile communication device. As described in more detail below, administrative device 210 may be used to input information pertaining to article or equipment resources of facility 100, including but not limited to, facility information, job zone information, personnel-specific information, article/equipment budgets, personnel voucher programs, article/equipment supply, historical resource information, and/or any suitable information pertaining to the management, allocation, distribution, supply, effectiveness, or use of articles/equipment used in facility 100.

In another aspect, network 230 can comprise any one or more communication channels configured to facilitate the transfer of information between any of administrative device 210, management server 220, and one or more personnel devices 240. In one embodiment, network 230 can comprise one or more wireless or wired communication channels, including but not limited to, the Internet, a transceiver or cell network, a local area network, a workstation peer-to-peer network, a direct link network, or any other suitable communication channels.

In a further aspect, management server 220 can be in communication with administrative device 210 and/or one or more personnel devices 240 via network 230. In one embodiment, management server 220 can remotely and/or dynamically manage access, permissions, and accounts associated with administrators and personnel of facility 100. Management server 220 may also store information associated with the management, allocation, distribution, supply, effectiveness, or use of articles/equipment used in facility 100. Further, any administrative client device 210 having proper authority or access credentials can be used to configure management server 220 and transmit information associated with facility 100, one or more job zones, personnel, articles, or equipment. As depicted in FIG. 2, management server 220 may comprise a single server. In alternative embodiments, however, management server 220 may comprise a plurality of servers in communication with one another and/or located across a number of physical locations.

System 200 can further comprise one or more personnel devices 240. Each personnel device 240 can be associated with one or more personnel 242 of facility 100. Like administrative device 210, personnel devices 240 can comprise any controller- or processor-based, a mobile communication device substantially similar to mobile device 110. Alternatively or additionally, client devices 130 can comprise one or more desktop computers or non-mobile, controller- or processor-based, mobile or non-mobile communication device, including but not limited to a desktop computer, cellphone, smartphone, laptop, tablet, terminal, or kiosk.

In one aspect, and as described in more detail herein, personnel 242 may use personnel device(s) 240 to request, order, purchase, check-in, and check-out articles or equipment. Personnel device(s) 240 may also be used to verify personnel account status (e.g., voucher availability), order status, current articles/equipment associated with personnel 242, and/or historical information associated with personnel 242.

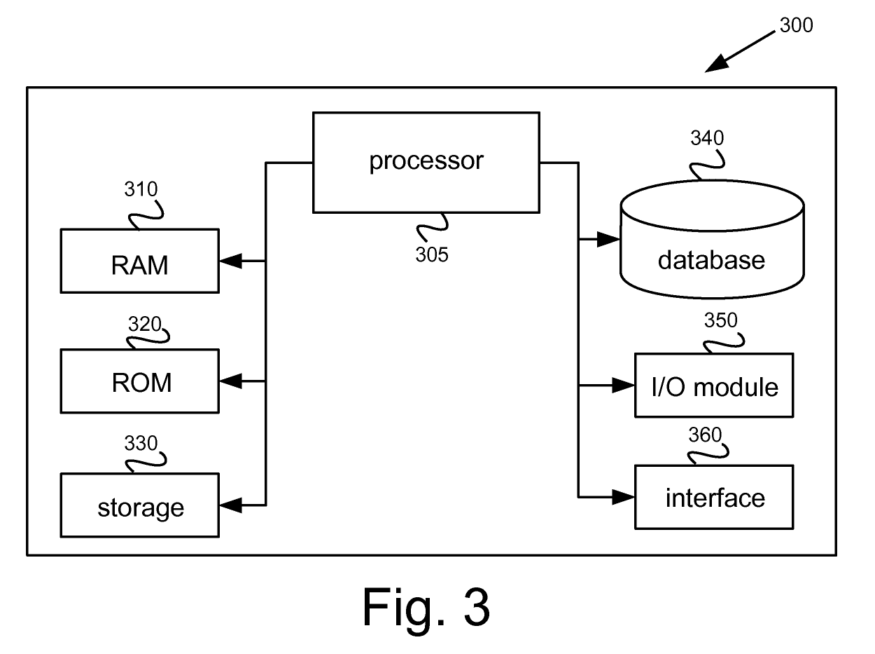

FIG. 3 depicts an illustrative processor-based computing system 300 representative of the type of computing system that can be present in or used in conjunction with any aspect of system 200 comprising electronic circuitry, including administrative device 210, management server 220, and one or more personnel devices 240. For example, processor-based computing system 300 can be used in conjunction with any one or more of transmitting signals to and from components of system 200, processing received signals, and storing, transmitting, or displaying information. Computing system 300 is illustrative only and does not exclude the possibility of another processor- or controller-based system being used in or with any of the aforementioned aspects of system 200.

In one aspect, system 300 can include one or more hardware and/or software components configured to execute software programs, such as software for storing, processing, and analyzing data. For example, system 300 may include one or more hardware components such as, for example, processor 305, a random access memory (RAM) module 310, a read-only memory (ROM) module 320, a storage system 330, a database 340, one or more input/output (I/O) modules 350, and an interface module 360. Alternatively and/or additionally, system 300 can include one or more software components such as, for example, a computer-readable medium including computer-executable instructions for performing methods consistent with certain disclosed embodiments. It is contemplated that one or more of the hardware components listed above may be implemented using software. For example, storage 330 can include a software partition associated with one or more other hardware components of system 300. System 300 can include additional, fewer, and/or different components than those listed above. It is understood that the components listed above are illustrative only and not intended to be limiting or exclude suitable alternatives or additional components.

Processor 305 can include one or more processors, each configured to execute instructions and process data to perform one or more functions associated with system 300. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 3, processor 305 may be communicatively coupled to RAM 310, ROM 320, storage 330, database 340, I/O module 350, and interface module 360. Processor 305 can be configured to execute sequences of computer program instructions to perform various processes, which will be described in detail below. The computer program instructions can be loaded into RAM for execution by processor 305.

RAM 310 and ROM 320 may each include one or more devices for storing information associated with an operation of system 300 and/or processor 305. For example, ROM 320 may include a memory device configured to access and store information associated with system 300, including information for identifying, initializing, and monitoring the operation of one or more components and subsystems of system 300. RAM 310 may include a memory device for storing data associated with one or more operations of processor 305. For example, ROM 320 may load instructions into RAM 310 for execution by processor 305.

Storage 330 can include any type of storage device configured to store information that processor 305 needs to perform processes consistent with the disclosed embodiments.

Database 340 may include one or more software and/or hardware components that cooperate to store, organize, sort, filter, and/or arrange data used by system 300 and/or processor 305. For example, database 340 may include user/personnel profile information, historical job zone or personnel information, predetermined articles or equipment for different zones, and various user preferences. Alternatively, database 340 may store additional and/or different information.

I/O module 350 may include one or more components configured to communicate information with a user associated with system 300. For example, I/O module 350 may comprise one or more buttons, switches, touchscreens, or microphones to allow a user to input parameters associated with system 300. I/O module 350 can also include a display including a graphical user interface (GUI) and/or one or more light sources for outputting information to the user. I/O module 350 can also include one or more communication channels for connecting system 300 to one or more peripheral devices such as, for example, a printer, a user-accessible disk drive (e.g., a USB port, a floppy, CD-ROM, or DVD-ROM drive, etc.), a microphone, a speaker system, or any other suitable type of interface device.

Interface 360 can include one or more components configured to transmit and receive data via a communication network, such as the Internet, a local area network, a workstation peer-to-peer network, a direct link network, a wireless network, or any other suitable communication channel. For example, interface 360 may include one or more modulators, demodulators, multiplexers, demultiplexers, network communication devices, wireless devices, antennas, modems, and any other type of device configured to enable data communication via a communication network.

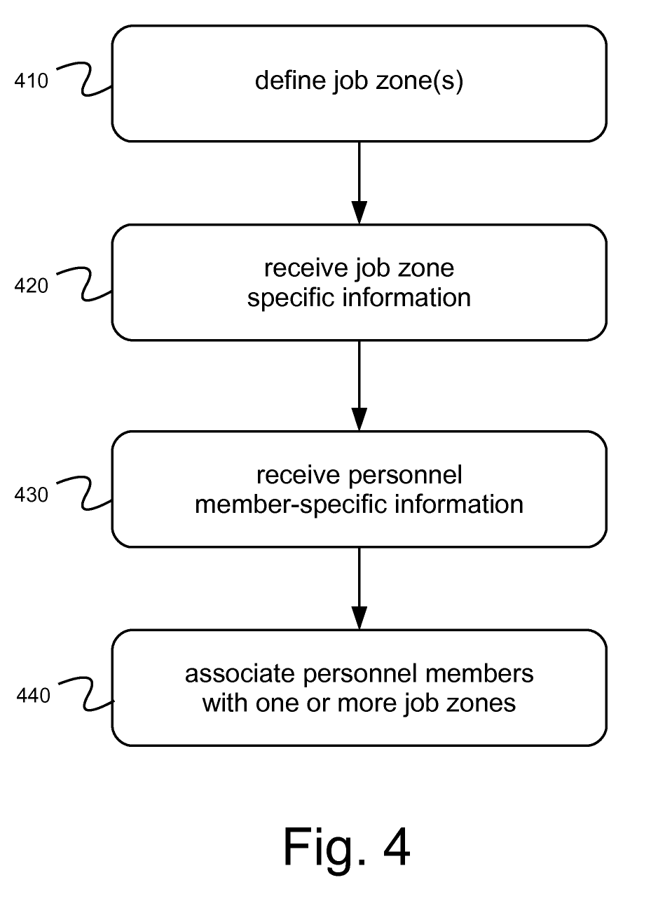

FIG. 4 depicts an illustrative embodiment of a method for associating one or more personnel with one or more job zones. At step 410, one or more job zones may be defined within facility 100. As discussed previously, facility 100 may be a discrete, physical location or it may be a “virtual” facility comprising a plurality of physical locations. Similarly, a job zone may comprise a discrete, physical location within a facility, virtual or otherwise, or a job zone may comprise a plurality of physical locations that share one or more characteristics. For example, facility 100 may be a poultry processing plant. In such an embodiment, one or more job zones may be defined, such as: a receiving job zone; a feedlot job zone; a poultry dressing job zone; a food preparation job zone; a packaging job zone; and a distribution/shipping job zone. It should be noted this example is provided only for illustrative purposes, and this disclosure may be applied to any suitable facility and corresponding job zone(s).

In one aspect, job zones may be defined based, at least in part, on the articles or equipment used by (or required for) personnel working within those job zones. For example, an environmental analysis of the job zone(s) can be performed based, at least in part, on environmental considerations, activities taking place in each zone, and/or safety considerations unique to the zone(s). The articles and equipment used by personnel within a job zone may depend upon a number of factors, including but not limited to, the type of work performed in the job zone, labor intensity, temperature, lighting, indoor/outdoor, time of year, sanitation requirements, geographic location, regulated safety standards, etc. Returning to the poultry processing plant example, the articles or equipment used by personnel working in an outdoor feedlot (e.g., heavy tread boots, work gloves, etc.) may be different from the articles or equipment used by personnel working in a food preparation area (e.g., apron, rubber sole shoes, aprons, rubber gloves, eye protection, hair nets). Thus, the outdoor feedlot and the food preparation area may be defined as different job zones. On the other hand, in some embodiments, where personnel groups having different roles or responsibilities within a facility nonetheless wear substantially similar articles or utilize substantially similar equipment (e.g., a first personnel group responsible for performing a final food processing stage and a second personnel group responsible for packaging the processed poultry for sale may be required to wear similar articles and/or use similar equipment), a single job zone may be defined that comprises those personnel groups.

At step 420, information associated with the environmental analysis for each defined job zone may be received. Such information may include the type of work performed in the respective zone, the labor intensity of such work, temperature information, lighting information, whether the zone is indoors or outdoors, any sanitation requirements, the geographic location of the zone, regulated safety standards, any articles or equipment required for personnel (e.g., required footwear, sanitation masks, etc.) a number of each article or piece of equipment to be associated with the zone, the number of personnel typically working in the zone at a given time, the number of personnel employed by the facility to work in the zone, and hours/days/times of year during which personnel are active within the zone. Information pertaining to each job zone may also comprise financial information, including but not limited to, a budget for articles and equipment used within the zone, historical budget information, and personnel voucher or financial aid information associated with personnel (as used herein, a “voucher” is meant to describe any money or other benefit an entity or employer may provide to personnel to offset costs incurred by personnel in purchasing articles or equipment for use within the scope of their work).

Information associated with individual personnel members can be received at step 430. In one embodiment, such member-specific information may include the member's name, date of birth, sex, height, weight, contact information (e.g., a physical address, phone number, and/or email address), emergency contact, and a date of employment. The member-specific information can also include health-related information, such as medical history information, one or more pre-existing health issues, and/or any special needs (e.g., allergies, access or transportation requirements, prescription eye wear requirements, physical disabilities, etc.). In further embodiments, the member-specific information may also comprise financial information, such as member-specific voucher or financial aid information, article or equipment purchase or use history, and salary or wages information. Additionally or alternatively, member-specific information may comprise information pertaining to the personnel member's use of the systems described herein, including but not limited to, access/permissions associated with the member (e.g., some personnel may have permission to order articles or equipment freely while others require a manager's or supervisor's approval), language preferences (for text displayed at a monitor or audio output from a speaker), and login credentials. Login credentials may be of any suitable form, for example, a username and password, RFID scan, retina scan information, fingerprint information, or a photo or facial markers information in embodiments employing facial recognition. Of course, the aforementioned examples of member-specific information are only illustrative of the possibilities and any other suitable information may be received or stored at step 430, including but not limited to, a physical location of a facility or job zone associated with the personnel member, the member's role or job title, employment history, and criminal background.

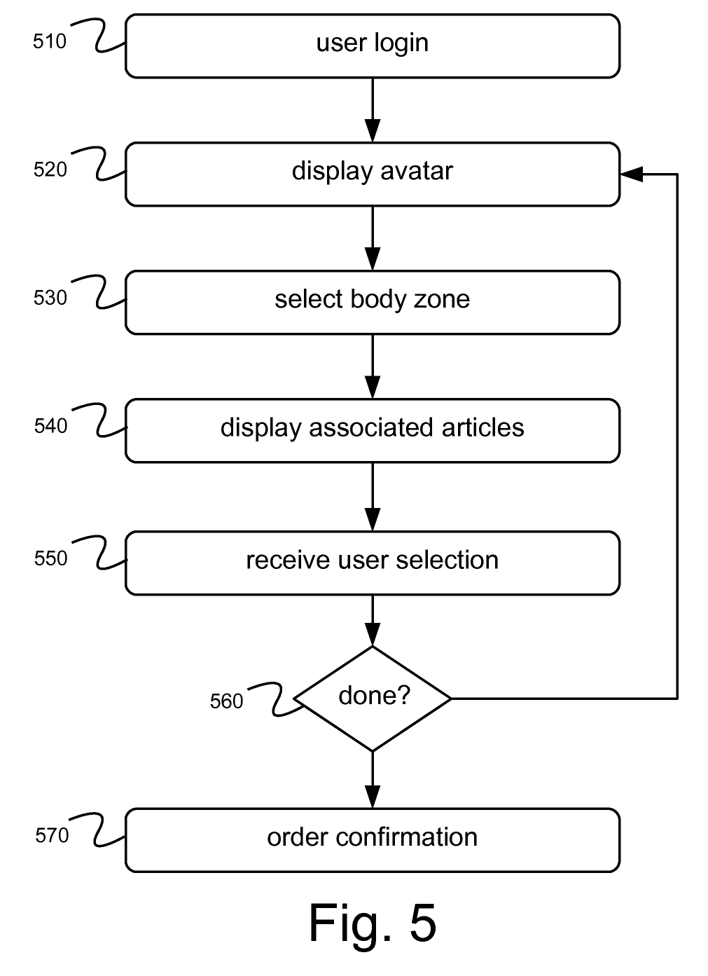

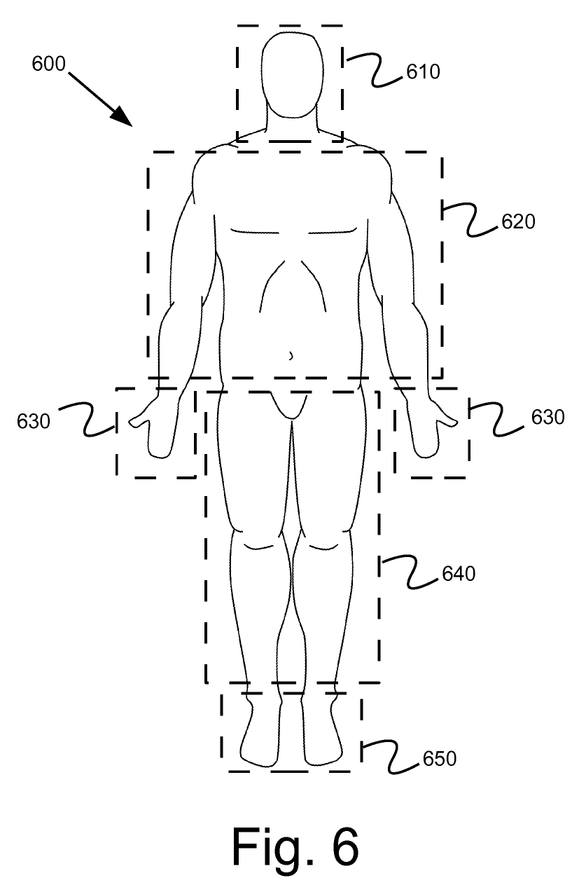

At step 440, each personnel member may be associated with one or more job zones of the facility. In this manner, any portion or all of the personnel member-specific information may be associated with any portion or all of the information associated with the specific job zone(s) in which the member is active or performs tasks. As will be described in more detail with respect to FIGS. 5 and 6, such an association can facilitate personnel's ordering, purchase, check-out, or check-in of articles and equipment designated for use within the personnel member's scope of work.

FIG. 5 depicts an illustrative embodiment of a method for personnel to order or purchase articles or equipment associated with the personnel member's job zone. Personnel's wearing of such articles or use of such equipment may be required, desirable, or otherwise useful in the course of performing work within the associated job zone.

At step 510, to initiate a personnel member's order or purchase of articles or equipment associated with the member's work, the member or other user (e.g., an equipment manager) can input login credentials at a personnel device 240 to gain access to the article or equipment management system. As discussed previously, this may involve inputting a username and password, RFID scan, providing a retina scan, fingerprint, or facial image, and/or any other suitable information for authenticating the personnel member's identity. In embodiments in which a manager or supervisor is initiating an order on behalf of the personnel member, the manager or supervisor may, in addition to inputting login credentials, input information identifying the personnel member.

At step 520, an avatar associated with the personnel member may be displayed at personnel device 240. In one embodiment, the avatar assumes a human form. In a further embodiment, the avatar may comprise a plurality of regions, each region corresponding to an area of the human body associated with one or more articles or pieces of equipment applicable to the member's work. For example, the avatar may comprise a foot region associated with footwear required to be worn on the job by the member's superior(s) or otherwise suited to the member's work within a job zone. The avatar may further comprise a head region associated with required or desirable headwear, eye protection, or hearing protection. The avatar is described in further detail below with respect to FIG. 6.

In use, the personnel member or other user may select a region of the avatar (e.g., via mouse click or finger tap) to display article and equipment options associated with that region at steep 530. Regions of the avatar may be differentiated based on dividing lines or they may be color-coded. For example, if the member desires to order footwear or another foot-related item, the foot region of the avatar may be selected.

At step 540, based, at least in part, on information pertaining to the personnel member and his or her job zone (described above with respect to FIG. 4), the articles and equipment displayed may be uniquely selected based on the member's needs or the environment in which the member works. For example, upon selecting a foot region of the avatar, personnel working in an outdoor job zone or a zone associated with heavy equipment may be presented with steel toe boots or heavy-duty footwear, while personnel working in a sanitized, indoor environment (e.g., food processing), may be presented with rubber sole shoes or sterile, disposable shoe covers.

In a further embodiment, the personnel member may be associated with sex, weight, and clothing size information. Using this information, an appropriate style or size of the articles or equipment presented to the member may be determined by the system.

The available items displayed to the personnel member upon selection of a region of the avatar may not only depend on personnel-specific or job zone information. Rather, a supervisor, administrator, or employer can preselect one or more available options and only the preselected options may be displayed to the personnel member. In this manner, an employer may be guaranteed that any articles or equipment ordered by personnel via the system will adhere to the employer's standards or guidelines regarding appropriate on-site articles and equipment. Further, articles or equipment can be preselected based on financial considerations. For example, where an employer offers each personnel member working in a particular job zone a $100 per year voucher for footwear, the system may only display footwear options to the personnel member that cost $100 or less. Alternatively, some displayed footwear options may be accompanied by a visual indicator that the item's cost exceeds the remaining balance of the member's voucher and the member will, therefore, need to pay for any additional cost beyond the remaining balance of the voucher.

At step 550, the personnel member or other user may select an article or piece of equipment to order or purchase (e.g., via mouse click or finger tap). In some embodiments, such a selection can be followed with requests for additional information regarding a style, color, size, etc. of the corresponding item. Alternatively, where the member's sex, weight, sizes, or other preferences are known, such requests for additional information may not be necessary.

After selecting an item for ordering, the personnel member or other user may be prompted to indicate whether the order is complete or if the member would like to order additional items at step 560. If the member indicates that he or she would like to order additional items, the process may return to step 520 where the avatar can be displayed and the member can order another item in a manner substantially similar to the previous item. If, on the other hand, the member indicates that his or her order is complete, the order can be finalized at step 570. In one embodiment, step 570 may comprise inputting payment information for completing the transaction. In another embodiment, a voucher may be applied to the member's order. The member may still be required to input payment information if his or her order exceeds the remaining balance of a voucher in a further embodiment.

One will appreciate that the systems and processes set forth herein not only streamline the ordering process from a personnel perspective (i.e., eliminates need to shop multiple vendors, locate approved equipment, negotiate pricing, request employer reimbursement where vouchers or financial aid are available), but also provides advantages to an employer. For example, budgets pertaining to the purchase of articles and equipment can be managed in real-time, popularity of articles and equipment can be determined, vouchers can be automatically tracked, managed, and processed, article and equipment lifespan can be estimated, and personnel behavior can be monitored.

FIG. 6 depicts an illustrative embodiment of an interface displayed to a personnel member during article or equipment ordering. In one aspect, the interface comprises an avatar 600 depicted in a human form. The avatar may be unisex, or it may display a female body form for female personnel and a male body form for male personnel.

In another aspect, the avatar comprises a plurality of body regions. In one embodiment, the body regions include a head region 610, an upper body region 620, a hand region 630, a lower body region 640, and a foot region 650. It should be noted, the aforementioned regions are only illustrative of the possibilities, and an avatar may comprise additional, fewer, or alternative regions. For example, in another embodiment, head region 610 may comprise an eye region, an ear region, and a mouth region.

In a further aspect, each region may be associated with one or more articles or equipment pieces corresponding to that area of the body. Thus, for example, head region 610 may be associated with one or more hats, hoods, eyewear, protective hearing wear, and masks. Upper body region 620 may be associated with shirts, jackets, aprons, and sleeves.

A personnel member desiring to order or purchase a particular article or equipment piece may select (or another user may select) the region of the “body” associated with the particular article or equipment piece. For instance, personnel seeking a pair of gloves may select hand region 630 of the avatar, while personnel seeking a pair of boots or shoe covers may select foot region 650. Not only does such an interface simplify the search for particular items, but it provides an intuitive way for personnel members to execute orders while avoiding potential language or literacy issues. As discussed above, in some embodiments, the regions of avatar 600 may be distinguished from one another by color, dividing lines, or any other suitable visual indicator.

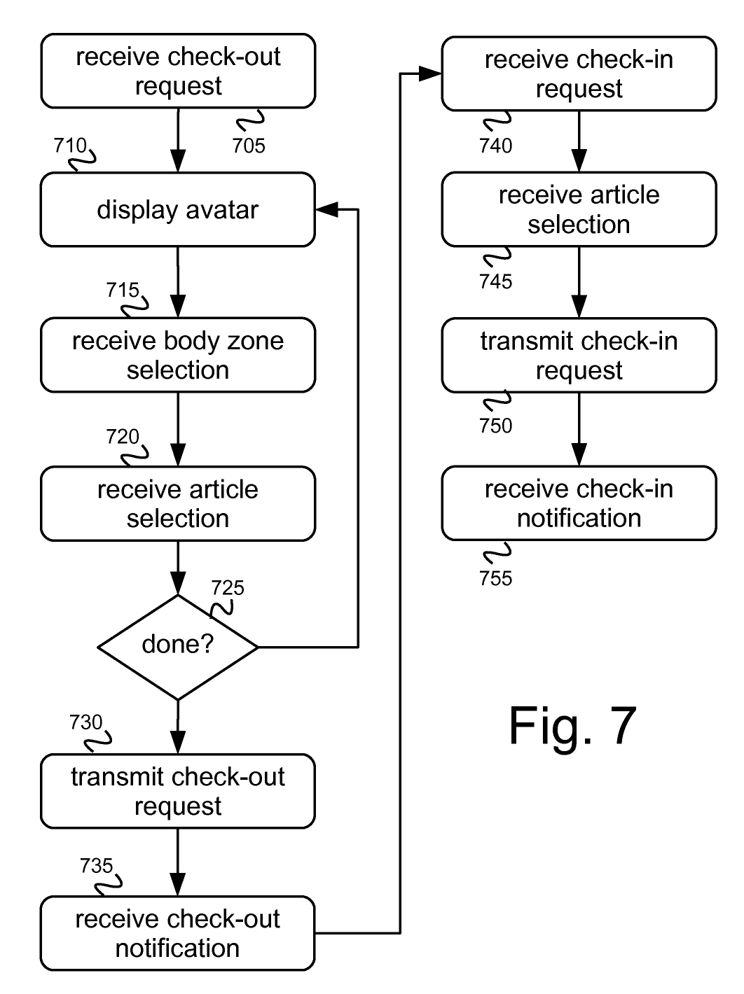

FIG. 7 depicts an illustrative embodiment of a method for checking out and checking in of articles or equipment. Although the example steps are discussed with regard to personnel checking in and out equipment, a separate user can alternatively perform one or more steps involved in checking in and out the equipment. For example, a manager may input the login credentials and oversee the process in one embodiment.

In one aspect, at step 705, personnel can check out articles or equipment by inputting login credentials substantially similar to those described with respect to FIG. 5 at step 510. This may involve inputting a username and password, RFID scan, providing a retina scan, fingerprint, or facial image, and/or any other suitable information for authenticating the personnel member's identity. Moreover, personnel may login at any suitable personnel device, such as a personal computer, laptop, smartphone, tablet, kiosk, or any other suitable controller- or processor-based device.

Upon verification of personnel's login credentials, an avatar substantially similar to the avatar depicted in FIG. 6 may be displayed at the personnel device at step 710. As described above with respect to other embodiments, to execute an article or equipment check out request, personnel can select a corresponding body zone of the avatar at step 715. For example, if a personnel member desires to check out footwear, the member can select a foot region of the avatar.

Based, at least in part, on information pertaining to the personnel member and his or her associated job zone(s), personnel member may be presented with articles and equipment corresponding to the member's needs or the environment in which the member works. For example, upon selecting a foot region of the avatar, personnel working in an outdoor job zone may be presented with one or more boots or shoes suitable for use in such an environment and/or pre-approved by management for such use. In a further embodiment, style and size of the displayed articles and equipment may be predetermined based, at least in part, on information associated with the personnel member. The personnel member can select one or more articles or pieces of equipment from the displayed options at step 720.

At step 725, upon receiving the member's selection, the member may be prompted to indicate whether the order is complete or if the member would like to check out additional items. If the member indicates that he or she would like to check out additional items, the process may return to step 710 where the avatar can be displayed and the member can select another body zone. Alternatively, if the member indicates that his or her check out request is complete, the request can be transmitted to an equipment manager, administrator, or other person in charge of article or equipment distribution at step 730. In one embodiment, the check-out request can be transmitted to an administrative device 210 (depicted in FIG. 2) associated with the manager, administrator, or other person.

Upon receipt of the check-out request, the manager may provide the requesting personnel member with the requested articles or equipment. The manager may then transmit a check-out notification or confirmation from administrative device 210 at step 735. In one embodiment, a record of the transaction may be stored at administrative device 210, personnel device 240, and/or management server 240. For example, information identifying the requesting personnel member, the manager, the articles or equipment checked out, and the time/date that the items were checked out may be stored.

Personnel may then check the article or equipment back in at step 740. Similar to the check-out process, at step 740, personnel can input login credentials at a personnel device 240. In some embodiments, the same personnel device 240 used to submit the check-out request may be used to submit a check-in request. In other embodiments, personnel may use a different personnel device 240 (for example, where check-out requests are made at a workplace kiosk dedicated to checking out articles or equipment and check-in requests are made at another workplace kiosk dedicated to checking in articles or equipment).

Upon verifying the personnel member's identify or login credentials, a list of all items currently checked out by the member may be displayed at the personnel device. The member may then select one or more of the displayed items to check in at step 745.

Similar to step 730, the check-in request may then be transmitted to an equipment manager, administrator, or other person in charge of article or equipment distribution at step 750. In one embodiment, the check-out request can be transmitted to the same administrative device 210 described with respect to step 730. Alternatively, the request may be transmitted to another administrative device 210, such as a device dedicated to article or equipment check-in.

Upon receipt of the check-in request, the manager may receive the articles or equipment from the personnel member. In some embodiments, the manager may further verify the identity of the individual checking in the items based, at least in part, on information associated with the earlier check-out transaction. In still further embodiments, the manager may be provided with an opportunity to submit any notes or ancillary information regarding the articles or equipment. For example, if one or more articles or equipment has been damaged, the manager can note such damage and associate it with the personnel member checking in the item.

After accepting the articles or equipment, the manager may then transmit a check-in notification or confirmation from administrative device 210 at step 755. In one embodiment, a record of the transaction may be stored at administrative device 210, personnel device 240, and/or management server 240. For example, information identifying the personnel member, the manager, the articles or equipment checked in, and the time/date that the items were checked in may be stored.

In a further aspect, check-out and check-in records may be compared to determine one or more articles or equipment pieces that have been checked out but not yet checked in. In such embodiments, a manager or other individual may determine when the outstanding items were checked out, who checked them out, what condition the items were in, and in which job zone the items were used.

In this manner, a manager, employer, or other individual can accurately track the location of company assets and the parties responsible for those assets. Further, based on historical transaction information, the manager or employer can effectively review personnel member's experience and performance with company assets, as well as the performance of the articles or equipment distributed to personnel. For example, it may be determined that one or more personnel members frequently damage, lose, or otherwise fail to return articles or equipment pieces, or it can be determined that a particular piece of equipment frequently fails or becomes damaged during use. This may indicate faulty equipment, equipment unsuitable for use within an associated job zone, or a need for further personnel training with respect to the equipment.

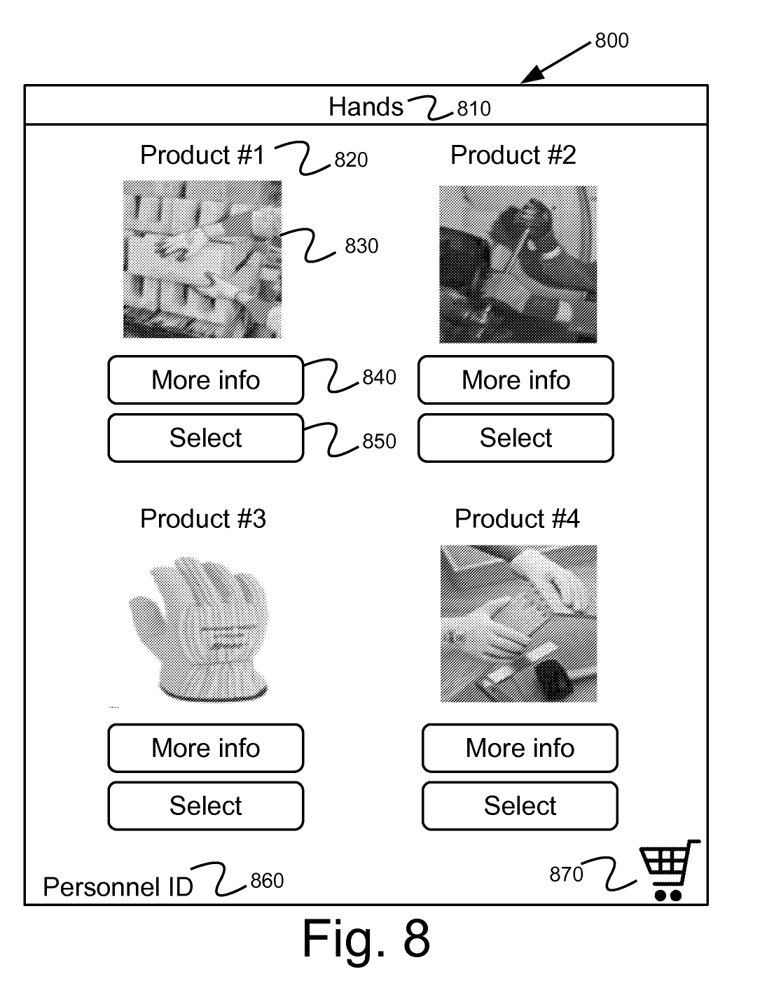

FIG. 8 depicts an illustrative embodiment of an interface 800 that may be displayed to personnel during article or equipment check-out. In one aspect, interface 800 may depict one or more items 820 available for check out. In one embodiment, the items 820 displayed are based, at least in part, on personnel information and associated job zone information. In another aspect, interface 800 may further comprise a body zone 810 of the avatar corresponding to the depicted items 820 and an option 840 for displaying additional information regarding the depicted items. In a further aspect, personnel may be able to select one or more items for checkout by selecting item 850. After selecting all items to be checked out associated with body zone 810, personnel may select item 870 (depicted in FIG. 8 as a shopping cart, but item 870 could also be any suitable image or text, such as “finished” or “check-out.”). In some embodiments, interface 800 may further comprise an identification number or some other information identifying the personnel member making the check out request.

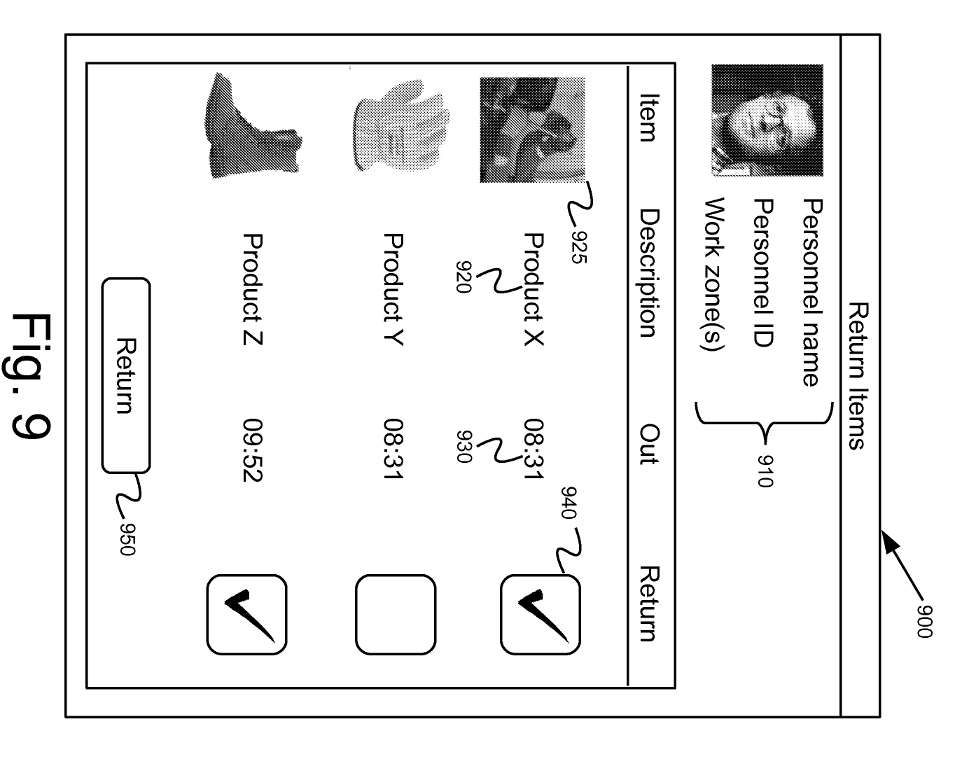

FIG. 9 depicts an illustrative embodiment of an interface 900 that may be displayed to personnel during article or equipment check-in. In one aspect, interface 900 may comprise personnel identification information 910, including but not limited to, the personnel member's name, identification number, and/or associated job zones. In a further embodiment, identification information 910 may comprise a photograph of the personnel member. In such embodiments, a manager or other individual charged with checking out equipment may confirm that the photograph matches the individual receiving the requested articles or equipment. In still further embodiments, identification information 910 may comprise a photograph taken at the time the personnel member checked out the article(s) or equipment piece(s). Such an image may prove useful if personnel ever dispute receiving one or more articles or pieces of equipment.

In another aspect, interface 900 may depict one or more items 920 that have been previously checked out by a personnel member or otherwise in the member's possession. Item 920 may comprise a name for the article or equipment, a brief description, and condition information. Item 920 may also be accompanied by an image 925 of item 920. In some embodiments, image 925 may be a stock photograph of the item. In other embodiments, image 925 may be a photograph taken of the item at the time it was checked out by the personnel member. In such an embodiment, image 925 may be used to determine if any damage was done to item 920 while it was checked out to the personnel member.

Interface 900 may further comprise time/date information 930 indicative of when item 920 was checked out to the personnel member. A selectable field 940 may also be displayed at interface 900. In use, personnel may select one or more selectable fields 940 corresponding to the items checked out to them that they wish to check back in. After selecting all items to be checked in, the personnel may select item 950 to transmit a check-in request.

While a number of embodiments have been illustrated and described, it will be appreciated that various changes can be made therein without departing from the spirit and scope of the disclosure. For example, though some methods presented herein may be described as a series of steps, it will be appreciated that one or more steps may occur simultaneously, in an overlapping fashion, and/or in a different order. The order of steps presented herein is only illustrative of the possibilities and the steps may be executed or performed in any suitable order or fashion. Moreover, the various features of the embodiments described herein are not mutually exclusive. Rather any feature of any embodiment described herein may be incorporated into any other suitable embodiment.

Additional features may also be incorporated into the described systems and methods to improve their functionality. Moreover, while the aforementioned systems and methods were described in an employment context and managing worksite resources, they may be used to order, check in, check out, or track items in any suitable context. For example, the systems and methods described herein may be used to manage classroom resources for students or teachers, or incorporated into a consumer shopping platform or prescription drug ordering and dispensing system.

Other embodiments of the aforementioned systems and methods will be apparent to those skilled in the art from consideration of the specification and practice of this disclosure. It is intended that the specification and the aforementioned examples and embodiments be considered as illustrative only, with the true scope and spirit of the disclosure being indicated by the following claims.

What is claimed is:

1. A device for checking out articles or equipment, the device comprising:
a display;
a computer-readable memory containing instructions; and
a processor in communication with the computer-readable memory and the display, wherein the processor executes the instructions to perform stages comprising:
identifying an individual;
determining a job zone associated with the individual;
displaying, at the display, an icon comprising a plurality of body regions;
receiving a selection of a first body region; and
displaying, at the display, a plurality of items, each item corresponding to the first body region and associated with the job zone.

2. The device of claim 1, further comprising:
receiving a selection of one or more of the plurality of items; and
transmitting a request to check out the selected one or more items to the individual.

3. The device of claim 1, wherein the identifying the job zone associated with the individual comprises:
receiving information corresponding to each of a plurality of job zones within a facility;
receiving information corresponding to the individual; and
associating the individual with at least one job zone from the plurality of job zones.

4. The device of claim 3, wherein the information corresponding to each of the plurality of job zones comprises items suitable for use within the respective job zone.

5. The device of claim 3, wherein the information corresponding to each of the plurality of job zones comprises a plurality of articles or equipment pre-approved for use by the individual within the respective job zone.

6. The device of claim 2, wherein the plurality of items are based, at least in part, on an environmental analysis of the job zone.

7. The device of claim 2, further comprising associating the individual with item condition information corresponding to each of the selected one or more items.

8. A non-transitory, computer-readable medium containing instructions that, when executed by a processor, cause the processor to perform steps comprising:
receiving personnel member information associated with a personnel member;
associating the personnel member with a first job zone from a plurality of job zones;
displaying an avatar comprising a plurality of body zones;
receiving a selection of a body zone from the plurality of body zones; and
determining at least one item corresponding to the selected body zone and associated with the first job zone.

9. The non-transitory, computer-readable medium of claim 8, wherein the at least one item is further associated with the personnel member information.

10. The non-transitory, computer-readable medium of claim 9, wherein the personnel member information comprises voucher information.

11. The non-transitory, computer-readable medium of claim 10, wherein the determining the at least one item is based, at least in part, on the voucher information.

12. The non-transitory, computer-readable medium of claim 11, further comprising displaying a visual indicator indicating whether a first value associated with the at least one item is less than or greater than a second value associated with the voucher information.

13. The non-transitory, computer-readable medium of claim 9, wherein the personnel member information comprises voucher information specific to each of the plurality of body zones.

14. A system for requesting articles, the system comprising:
a personnel device; and
an administrative device,
wherein the personnel device is configured to:
receive information identifying a user;
display an icon representing the human body, the icon comprising a plurality of body zones;
receive a selection by the user of a first body zone;
display a plurality of articles corresponding to the first body zone and associated with a role of the user;
receive a selection of one or more of the plurality of articles; and
transmit a check-out request to the administrative device comprising the selected articles, and
wherein the administrative device is configured to:
receive the check-out request from the personnel device;
display the selected articles and information identifying the user; and
transmit a confirmation message indicating that the user has received the selected articles.

15. The system of claim 14, wherein the role of the user is determined based, at least in part, on a discrete work environment within a facility associated with the user.

16. The system of claim 14, wherein the administrative device is further configured to receive condition information associated with each selected article.

17. The system of claim 16, wherein the condition information comprises information pertaining to any damage or defects associated with each selected article.

18. The system of claim 14, wherein the administrative device is further configured to receive an image of the user receiving the selected articles.

19. The system of claim 14, wherein the personnel device is further configured to:
receive a check-in request from the user to return one or more of the selected articles; and
transmit the check-in request to the administrative device.

20. The system of claim 19, wherein the administrative device is further configured to:
receive the check-in request; and
transmit a confirmation message indicating that the user has returned the one or more selected articles.
